(19) United States
(12) Patent Application Publication
(10) Pub. No.: US 2022/0113995 A1
(43) Pub. Date: Apr. 14, 2022

(54) DISPLAYING GRAPHICAL USER INTERFACES BASED ON AUDIO SESSION STATES

(71) Applicant: Hewlett-Packard Development Company, L.P., Spring, TX (US)

(72) Inventors: Andre da Fonte Lopes da Silva, Palo Alto, CA (US); Walter Flores Pereira, Palo Alto, CA (US); Carol Tatsuko Ozaki, Palo Alto, CA (US); Richard Edward Hodges, Spring, TX (US); Thomas Hardy Simes, Palo Alto, CA (US)

(73) Assignee: Hewlett-Packard Development Company, L.P., Spring, TX (US)

(21) Appl. No.: 17/419,472

(22) PCT Filed: Jul. 1, 2019
(86) PCT No.: PCT/US2019/040149

§ 371 Date: Jun. 29, 2021

(51) Int. Cl. G06F 9/451; G06F 9/455; G06F 9/54

(52) U.S. Cl. CPC G06F 9/451; G06F 9/542; G06F 9/455

(57) ABSTRACT

An example device includes a display to output a common graphical user interface (GUI) of a common application to manage communications applications. The communications applications include a first communications application that includes a first GUI. The device further includes a processor coupled to the display. The processor is to monitor an audio session state of the first communications application. The processor is further to deactivate the first GUI and activate the common GUI in response to detection of an expired state as the audio session state.

### BACKGROUND

Graphical user interfaces (GUIs) provide the ability for users to interact with computing devices. Different applications often provide different GUIs to facilitate different functionality.

### BRIEF DESCRIPTION OF THE DRAWINGS

FIG. 1 is a block diagram of an example device to switch between GUIs based on an audio session state.

FIG. 2 is a block diagram of an example programmatic architecture to switch between GUIs based on an audio session state.

FIG. 3 is a schematic diagram of communications application data and audio session events.

FIG. 4 is a flowchart of an example method to switch among applications using audio session state information.

FIG. 5 is a flowchart of an example method to switch among common and communications applications using subscribed audio session state information.

FIG. 6 is a schematic diagram of transition among application GUIs based on audio session state information.

### DETAILED DESCRIPTION

Coordinating the display of GUIs of different applications to provide a consistent, expected, and/or intuitive user experience may be difficult or impossible due to inherent limitations of such applications. For example, it is common for users to install various different communications applications for video conferencing, voice calls, and similar communications sessions. Switching among the different GUIs of such applications may not be practical when such applications lack enabling functionality, such as robust application programming interfaces (APIs).

A unified platform for various different communications applications may be provided. A common application may provide a central point of audio/video call initiation and a consistent or harmonized user interface.

A communications application may lack an API suitable for use with a common application. This would complicate switching between the common application's GUI and the GUI of the communications application. Specifically, when a communications session using a specific communications application is ended, the user may expect to return to the common application's GUI, which was the starting point to initiate the call. Switching back to the common application's GUI may be impractical without using a workaround technique such as screen scraping. Screen scraping, however, is susceptible to failure due to unpredictable changes in the GUI of communications applications, particularly if such applications are provided by third parties.

The common application may monitor audio session states and handle GUI transitions based on audio session state information relevant to the communications applications. When a communications session is underway using a specific communications application, the common application may detect an expiry of the audio session for that communications application. In response, the common application may switch back to its GUI as may be expected by a user who initiated the call at the common application. The common application may query an operating system that hosts the applications to obtain audio session states of various supported communications applications.

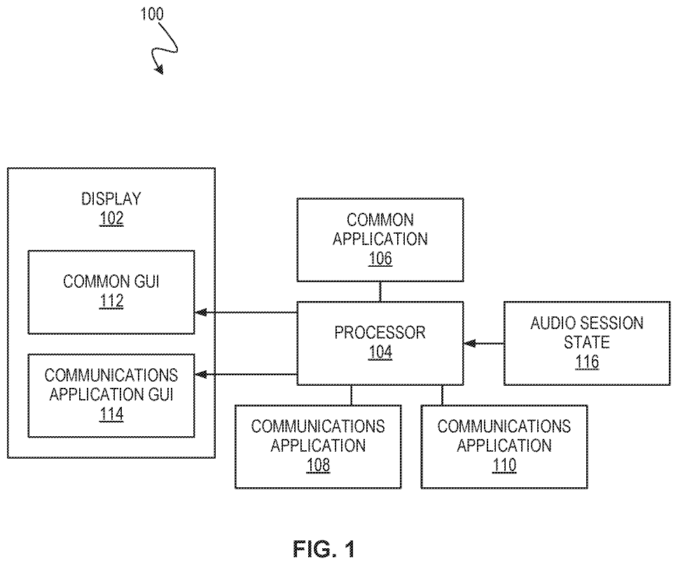

FIG. 1 shows an example device 100 to switch between GUIs based on an audio session state. The device 100 may be a computing device, such as a notebook computer, desktop computer, conference room computing system, tablet computer, smartphone, or the like. The device 100 includes a display 102 and a processor 104 coupled to the display 102.

The display 102 may include a liquid crystal display (LCD), light-emitting diode (LED) display, projector, or similar. The display 102 may be connected to the processor 104 via a display connection, such as an HDMI connection, a DisplayPort connection, or similar. The display 102 may be connected to the processor 104 via a cable, an integrated display interface, or similar.

The processor 104 may include a central processing unit (CPU), a microcontroller, a microprocessor, a processing core, a field-programmable gate array (FPGA), or a similar device capable of executing instructions. The processor 104 may cooperate with a non-transitory machine-readable medium to execute instructions, such as random-access memory (RAM), read-only memory (ROM), electrically-erasable programmable read-only memory (EEPROM), flash memory, a storage drive, an optical disc, or similar. The processor 104 may control operations of the display 102, such as selection and formatting of information to output at the display 102.

The processor 104 may execute a common application 106 and a plurality of communications applications 108, 110. That is, the processor 104 may execute a common application 106 and a first communications application, a second communications application, and so on. Examples of communications applications include Skype™, Zoom Video Conferencing™, Google Meet™, and similar. The processor 104 may execute the common application 106 and a communications application 108, 110 simultaneously.

The common application 106 manages the plurality of communications applications 108, 110. For example, the common application 106 may be used to initiate a communications session, such as a video conference, voice call, or similar, between the device 100 and another device using a selected individual communications application 108, 110. The common application 106 may be considered a launchpad application that launches and logs into the communications application 108, 110 and allows activation of a selected communications application 108,110.

The display 102 may output a common GUI 112 of the common application 106. The common GUI 112 may include a user interface component, such as a button, to initiate a communications application 108, 110. The display 102 may output the common GUI 112 when no communications session is active to allow a user to select a communications application 108, 110 with which to initiate a communications session.

A communications application 108 includes a communications application GUI 114. The GUI 114 may be specific to the communications application 108 and may include user interface components to initiate, configure, and end communications sessions, such as video conferences, voice calls, or similar. Each of the communications applications 108, 110 may include a respective GUI. That is, a first communications application may include a first GUI, a second communications application may include a second GUI, and so on. For sake of explanation, the GUI 114 will be discussed as part of the communications application 108.

The display 102 may output the communications application GUI 114 during an active session with the underlying communications application 108. During the session, the common GUI 112 may be hidden. For example, prior to initiation of a communications session, the common GUI 112 may be displayed on an active desktop and the communications application GUI 114 may be displayed on an inactive desktop. Then, when the communications session is initiated, the desktop containing the communications application GUI 114 may be activated and the desktop containing the common GUI 112 may deactivated. Such desktop functionality may be provided by an operating system, such as Microsoft Windows 10™. For example, virtual desktops may be accessed via an application programming interface or API exposed to applications by the operating system (e.g., through a programmatic interface such as “|VirtualDesktopManager” in Windows 10™).

The common GUI 112 may receive user input to initiate a communications session. Hence, the common GUI 112 may activate the communications application 108 and trigger display of the communication application's GUI 114 without user input or intervention.

When the communications session is ended (e.g., a user hangs up the call), common GUI 112 is automatically activated, so that the user may be returned to the GUI that initiated the communications session without user input or intervention. Returning to the common GUI 112 may be behavior that is expected by the user or may provide an intuitive user experience, as opposed to continuing to display the communication application GUI 114 after the communications session ends. A user may be unfamiliar with a communication application GUI 114 and may wish to return to the common GUI 112, or a user may not expect to have the communication application GUI 114 in focus once the session is over. Moreover, prior to the communications session, the user may have been using the common application 106 for another task and may expect efficient return to that task.

An audio session is initiated as part of a communications session to facilitate verbal communications among users. The audio session may be initiated by the operating system as associated with the activated communications application 108, 110. The processor 104 monitors a state 116 of the audio session to determine when to deactivate the communication application GUI 114 and reactivate the common GUI 112 for presentation at the display 102. The common application 106 may include instructions that are executed by the processor 104 to monitor the audio session state 116. The processor 104 may subscribe to audio session events. This may be achieved through an API exposed by the operating system, such as through the “|AudioSessionControl” and/or “|AudioSessionEvents” interfaces in Windows 10™.

When the processor 104 detects an expired state as the audio session state 116, meaning that the call at the communications application 108, 114 has ended, the processor 104 deactivates the communication application GUI 114 and activates the common GUI 112 by, for example, deactivating and activating respective virtual desktops. As such, the common application 106 need not rely on a signal from the communications application 108, 110 to indicate that the call has ended. The common application 106 can independently determine that the call has ended by monitoring the relevant audio session state 116. The common GUI 112 may thus be reactivated without user input or intervention.

In other examples, different kinds of applications may include different GUIs that are selectively displayed based on detection of an expired audio session of an application. Examples of such kinds of applications include audio playback applications, video playback applications, games, and similar.

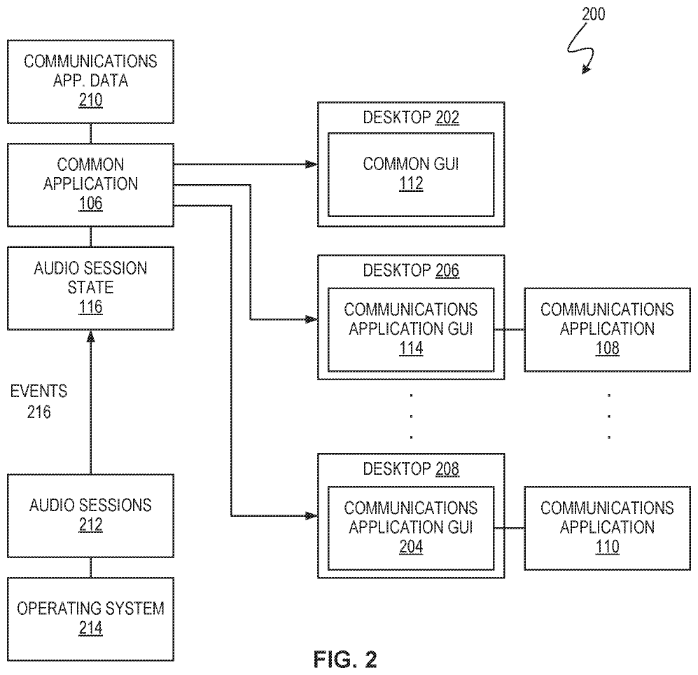

FIG. 2 shows an example programmatic architecture 200. The programmatic architecture 200 may be used with any of the devices or methods described herein. The devices and methods disclosed herein may be referenced for description not repeated here, with like terminology and/or like reference numerals indicating like components.

A common application 106 may output a common GUI 112 to a desktop 202 of a computing device. Different communications applications 108, 110 may output respective communications application GUIs 114, 204 to respective desktops 206, 208. That is, a first communications application may output a first GUI, a second communications application may output a second GUI, and so on. One desktop 202, 206, 208 may be selected to be displayed at a given time, while other the desktops 202, 206, 208 may be hidden. As such, the GUIs 112, 114, 204 may be selectively presented to the user.

The common application 106 and communications applications 108, 110 may be continuously executed. When the common application 106 is launched, the common application 106 may reference communications application data 210 to launch the communications applications 108, 110 and log the user into the communications applications 108, 110, such as by providing a name and password. The communications application data 210 may contain launch commands that start the communications applications 108, 110 at their respective desktops 206, 208.

While the desktop 202 containing the common GUI 112 of the common application 106 is active, a user may use the common GUI 112 to activate a communications application 108, 110 to carry out a video conference, voice call, or similar communications session. As part of the communications session, an audio session 212 may be created by an operating system 214. The selected communications application 108, 110 may trigger the creation of the audio session 212 through an API exposed by the operating system 214.

The common application 106 may receive notifications of audio session events 216. The common application 106 may subscribe to such notifications by making a request to the operating system 214. Examples of audio session events include volume change or mute, disconnection, state change (e.g., active, inactive, expired), and similar. An identity of a communications application 108, 110 may be stored as data 210 accessible to the common application 106. An identity may include an application name, an application path, a process identifier, or similar. A communications application identity may be preprogrammed at the common application 106 or may be obtained at runtime. The identity of a communications application 108, 110 may be used to subscribe to audio event notifications for that application 108, 110.

The common application 106 may initiate switching from the common GUI 112 to a communications application GUI 114, 204 when activating a respective communications application 108, 110. The common application 106 may issue a command to an API of the operating system 214 to switch to the desktop 206, 208 containing the relevant communications application GUI 114, 204. The common application 106 and unselected communications application 108, 110 may continue to be executed but their respective GUIs may be hidden by virtue of the change in desktop. In other examples, the operating system 214 may automatically switch to the desktop 206, 208 of the selected communications application 108, 110 when the communications session is initiated.

When the communications session is ended by, for example, a local or remote user ending the session, the operating system 214 may expire the associated audio session 212 and the common application 106 may receive a notification of an event 216 indicating the expired state of the associated audio session. In response to such event, the common application 106 may issue a command to the operating system 214 to switch to the desktop 202 that contains the common GUI 112. As such, the user may be returned to the common GUI 112 without input or intervention at the selected communications application GUI 114, 204, aside from perhaps pressing an end call button or similar user interface component.

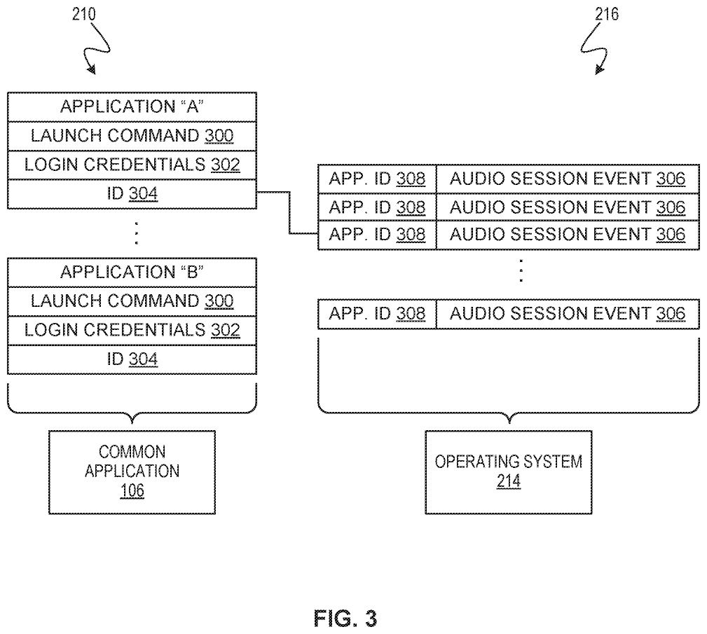

FIG. 3 shows examples of communications application data 210 and audio session events 216.

Communications application data 210 may store application launch commands 300, login credentials 302, and identifiers 304 for various communications applications. A common application 106 may reference an application launch command 300 to launch a communications application that is not already running. The common application 106 may reference login credentials 302, which may include a username and password previously provided by a user, to log into a communications application.

Specific audio session events 306 may be associated with specific application identifiers 308. An operating system 214 may issue a callback to the common application 106 when a subscribed event occurs. Other programmatic signaling mechanisms may be used. As such, the common application 106 may be informed of events relevant to the communications applications. The application identifiers 308 of audio session events 306 may correspond to identifiers 304 stored in the communications application data 210, so that the common application 106 may determine when an associated communications application has ended its video conference or voice call. An identifier 304 and an associated application identifier 308 may be of the same form, or of different forms which each indicate the same communications application. For example, a particular identifier 304 may be a programmatic object, and its associated application identifier 308 may be a string, provided that the particular identifier 304 and its associated application identifier 308 match and indicate the same communications application. Matching an identifier 304 to an application identifier 308 of a different format may involve a format conversion. The common application 106 may thereby obtain notifications of audio session events 306 indicating expired states of audio sessions for application identifiers 308 that match communications applications identifiers 304 of interest. As such, the common application 106 may switch back to the common GUI at the appropriate time.

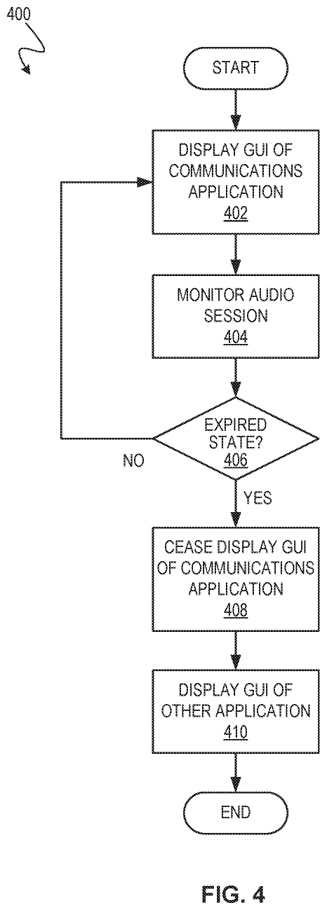

FIG. 4 shows an example method 400 to switch among applications using audio session state information. The method 400 may be performed with any of the devices or architectures discussed herein. The method 400 may be embodied as processor-executable instructions, which may be stored in a non-transitory machine-readable medium.

At block 402, a GUI of a communications application is displayed. The communications application may facilitate a video/audio call between a user of the GUI and a remote user. The GUI of a communications application may provide for user configuration of the call and ending of the call.

At block 404, during the call, an audio session of the communications application is monitored. This may include querying an operating system that hosts the communications application. The operating system may provide expose an API that allows subscription to audio session event notifications.

At block 406, it is determined whether the audio session of the communications application has expired. The audio session may expire in response to a user input that ends the call. For example, a user may press a button at the GUI of the communications application to end the call and, in response, the communications application may command the operating system to end the audio session. A notification of an audio session expired state may be issued by the operating system. Display of the GUI of the communications application and monitoring of the audio session may continue, at blocks 402 and 404, until expiry of the audio session.

At block 408, expiry of the audio session is detected. In response, the GUI of the communications application ceases being displayed. Further, a GUI of another application, such as a common application that supports a plurality of communications applications, is displayed, at block 410. As such, detection of the expiry of the audio session triggers the presentation of another GUI. Switching between display of various GUIs may be achieved by instructing the operating system to switch among virtual desktops, where a particular virtual desktop contains a particular GUI.

The method 400 thus switches among different GUIs based on detection in a change of audio session state. This may allow a user to be returned to common application GUI, automatically without other input or intervention, after ending a communications session at a communications application GUI.

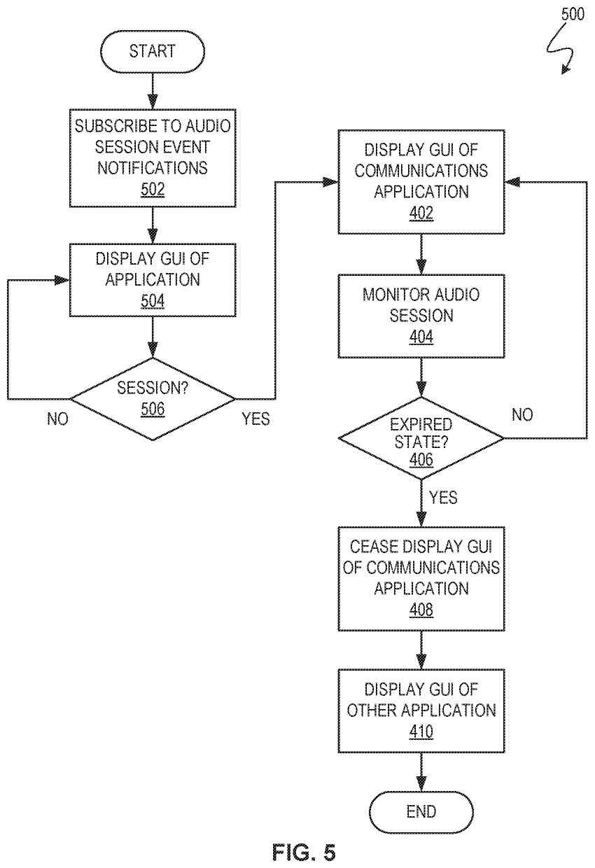

FIG. 5 shows an example method 500 to switch among common and communications applications using subscribed audio session state information. The method 500 may be performed with any of the devices or architectures discussed herein. The method 500 may be embodied as processor-executable instructions, which may be stored in a non-transitory machine-readable medium.

At block 502, an application, such as a common application, subscribes to audio session event notifications, as may be provided by an operating system through which the application is executed. A common application may be associated with a plurality of communications applications and may subscribe to audio session event notifications for each of such communications applications that are running.

At block 504, a GUI of the application is displayed. A common application may provide for user selection of a communications application to use for a video conference, voice call, or similar communications session. The GUI of the common application may include user interface components to switch to a GUI of a selected communications application.

Through block 506, the GUI of the common application continues to be displayed until user input to initiate a communications session with a communications application is received.

In response to such user input, which may include a button press to initiate or answer a call, the GUI of the communications application is display, at block 404. The GUI of the communications application continues to be displayed during the communications session, via blocks 404, 406, until expiry of the audio session is detected via notification received from the subscription made at block 502. Then, at blocks 408, 410, in response to the notification, display switches from the GUI of the communications application back to the GUI of the common application, so that the user may be automatically returned to the point of communications session initiation.

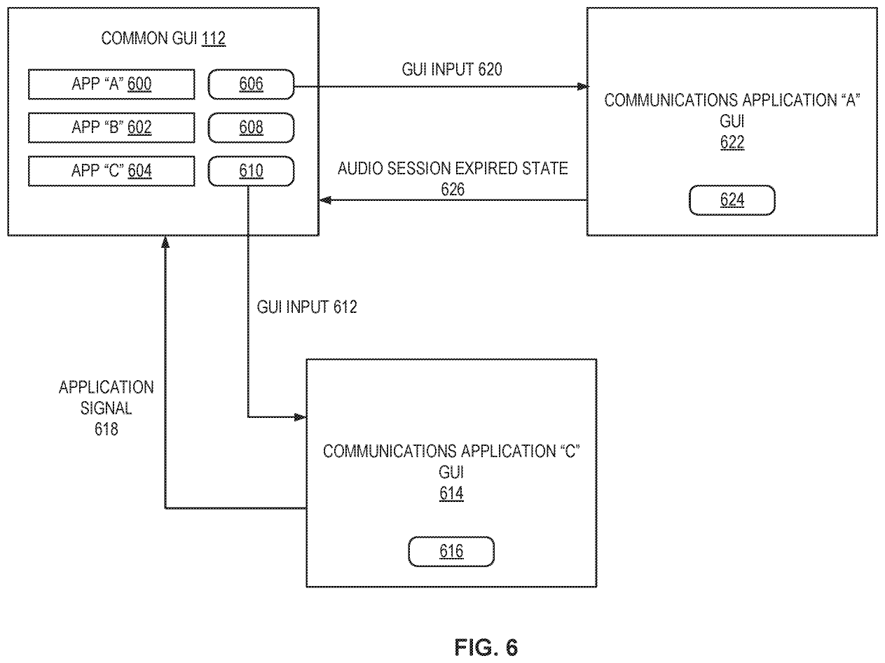

FIG. 6 shows example GUIs of example applications, such as a common application and several communications applications.

A GUI 112 of the common application may display information 600, 602, 604 of respective communications applications. Such information may include status information (e.g., an indication of whether the application is running and logged into), calendar/schedule information of upcoming conferences/calls, a name of the application, a logo of the application, and similar. The common GUI 112 may further include user interface components 606, 608, 610 for the communications applications, such as buttons to initiate or answer video/audio calls. The common application may subscribe to audio session event notifications, as provided by an operating system, for the communications applications. This may be done for each supported communications application when executed or when a communications session begins with a communications application.

A user may provide GUI input 612 through a user interface component 610 of a specific communications application to switch to a GUI 614 of the communications application. For example, the GUI input 612 may initiate a voice/video call. The user may end the call through a user interface component 616, such as a “hang up” button, of the communications application GUI 614. The communications application may provide a signal 618 to the common application, such as by an API callback or similar, to inform the common application that the call has ended. In response, the common application may switch to back to the common GUI 112 and the communications application GUI 614 may cease being displayed.

With respect to another communications application, which may not be capable of providing an API callback or similar signal, a user may provide GUI input 620 through a user interface component 606 of such communications application to switch to a GUI 622 of such communications application. For example, the GUI input 620 may initiate a voice/video call, which may proceed though the communications application GUI 620. The communications application GUI 620 may display video for the call as well as other user interface components to control the call. The user may end the call through a user interface component 624, such as a “hang up” button.

When the communications session is ended, the communications application releases its resources. This includes release of audio session resources provided by the operating system. As such, an operating system may issue a notification indicating an expired state of the audio session. The common application, having subscribed to such event notifications, receives an indication of the expired state 626 and may, in response, instruct the operating system to switch to back to the common GUI 112. As such, the user may be automatically returned to the common GUI 112 without an API callback or similar signal 618 being provided by the communications application.

In view of the above, it should be understood that coordinating the display of GUIs of different applications may be facilitated through the monitoring of audio session state. As such, application GUIs may be switched in a consistent, expected, and/or intuitive manner, even when an application does not itself support the relevant functionality.

It should be recognized that features and aspects of the various examples provided above can be combined into further examples that also fall within the scope of the present disclosure. In addition, the figures are not to scale and may have size and shape exaggerated for illustrative purposes.

1. A device comprising:
a display to output a common graphical user interface (GUI) of a common application to manage a plurality of communications applications, the plurality of communications applications including a first communications application that includes a first GUI; and
a processor coupled to the display, the processor to monitor an audio session state of the first communications application, the processor further to deactivate the first GUI and activate the common GUI in response to detection of an expired state as the audio session state.

2. The device of claim 1, wherein the processor is to monitor the audio session state through an operating system with which the common application and the first communications application are executable.

3. The device of claim 1, wherein the processor is to subscribe to audio session events to monitor the audio session state.

4. The device of claim 3, wherein the processor is to:
detect the expired state in subscribed audio session events; and
in response to detection of the expired state, trigger presentation of the common GUI on the display.

5. The device of claim 4, wherein the processor is further to, in response to detection of the expired state, deactivate output of the first GUI at the display.

6. The device of claim 1, wherein, in response to detection of the expired state, the processor is to switch from a desktop containing the first GUI to another desktop containing the common GUI.

7. A device comprising:
a display to output a first graphical user interface (GUI) of a first application and a second GUI of a second application; and
a processor coupled to the display, the processor to control display of the first GUI and the second GUI, the processor further to subscribe to audio session state notifications of the second application through an operating system, the processor further to switch from displaying the second GUI to displaying the first GUI in response to receiving an audio session notification indicating an end of an audio session of the second application.

8. The device of claim 7, wherein the first application is a common application to initiate a video or audio communications session through the second application.

9. The device of claim 7, wherein the processor further to switch from displaying the first GUI to displaying the second GUI in response to receiving a user input at a user input component of the first GUI.

10. The device of claim 7, wherein the processor is to output the first GUI to a first virtual desktop and output the second GUI to a second virtual desktop.

11. The device of claim 10, wherein the processor is to switch from displaying the second GUI to displaying the first GUI by deactivating the second virtual desktop and activating the first virtual desktop.

12. A method comprising:
displaying a graphical user interface (GUI) of a communications application;
monitoring an audio session of the communications application:
in response to detecting expiry of the audio session:
ceasing display of the GUI of the communications application; and
displaying a GUI of another application.

13. The method of claim 12, further comprising:
displaying the GUI of the other application prior to displaying the GUI of the communications application;
receiving a user input to initiate a communications session with the communications application; and
displaying the GUI of the communications application during the communications session.

14. The method of claim 12, further comprising:
subscribing to notifications of audio session events of an operating system.

15. The method of claim 12, wherein ceasing display of the GUI of the communications application and displaying a GUI of another application comprise switching between virtual desktops.
